(19) United States
(12) Patent Application Publication
(10) Pub. No.: US 2018/0056476 A1
(43) Pub. Date: Mar. 1, 2018

(54) MONITORING OF POLISHING PAD THICKNESS FOR CHEMICAL MECHANICAL POLISHING

(71) Applicant: Applied Materials, Inc., Santa Clara, CA (US)

(72) Inventors: Jimin Zhang, San Jose, CA (US); Zhihong Wang, Santa Clara, CA (US); Harry Q. Lee, Los Altos, CA (US); Brian J. Brown, Palo Alto, CA (US); Wen-Chiang Tu, Mountain View, CA (US); William H. McClintock, Los Altos, CA (US); Wei Lu, Fremont, CA (US)

(21) Appl. No.: 15/686,936

(22) Filed: Aug. 25, 2017

Related U.S. Application Data
(60) Provisional application No. 62/380,332, filed on Aug. 26, 2016.

(51) Int. Cl. B24B 37/005; B24B 53/017; G01B 7/06

(52) U.S. Cl. CPC B24B 37/005; G01B 7/10; B24B 53/017

(57) ABSTRACT

An apparatus for chemical mechanical polishing includes a platen having a surface to support a polishing pad, a carrier head to hold a substrate against a polishing surface of the polishing pad, a pad conditioner including a conductive body to be pressed against the polishing surface, an in-situ polishing pad thickness monitoring system including a sensor disposed in the platen to generate a magnetic field that passes through the polishing pad, and a controller configured to receive a signal from the monitoring system and generate a measure of polishing pad thickness based on a portion of the signal corresponding to a time that the sensor is below the conductive body of the pad conditioner.

### CROSS-REFERENCE TO RELATED APPLICATIONS

This application claims priority to U.S. Provisional Application Ser. No. 62/380,332, filed Aug. 26, 2016, the disclosure of which is incorporated by reference.

### TECHNICAL FIELD

The present disclosure relates to monitoring of a polishing pad used in chemical mechanical polishing.

### BACKGROUND

An integrated circuit is typically formed on a substrate by the sequential deposition of conductive, semiconductive, or insulative layers on a silicon wafer. A variety of fabrication processes require planarization of a layer on the substrate. For example, one fabrication step involves depositing a conductive filler layer on a patterned insulative layer to fill the trenches or holes in the insulative layer. The filler layer is then polished until the raised pattern of the insulative layer is exposed. After planarization, the portions of the conductive filler layer remaining between the raised pattern of the insulative layer form vias, plugs and lines that provide conductive paths between thin film circuits on the substrate.

Chemical mechanical polishing (CMP) is one accepted method of planarization. This planarization method typically requires that the substrate be mounted on a carrier head. The exposed surface of the substrate is placed against a rotating polishing pad. The carrier head provides a controllable load on the substrate to push it against the polishing pad. A polishing liquid, such as slurry with abrasive particles, is supplied to the surface of the polishing pad.

After the CMP process is performed for a certain period of time, the surface of the polishing pad can become glazed due to accumulation of slurry by-products and/or material removed from the substrate and/or the polishing pad. Glazing can reduce the polishing rate or increase non-uniformity on the substrate.

Typically, the polishing pad is maintained in with a desired surface roughness (and glazing is avoided) by a process of conditioning with a pad conditioner. The pad conditioner is used to remove the unwanted accumulations on the polishing pad and regenerate the surface of the polishing pad to a desirable asperity. Typical pad conditioners include an abrasive head generally embedded with diamond abrasives which can be scraped against the polishing pad surface to retexture the pad. However, the conditioning process also tends to wear away the polishing pad. Consequently, after a certain number of cycles of polishing and conditioning, the polishing pad needs to be replaced.

### SUMMARY

In one aspect, an apparatus for chemical mechanical polishing includes a platen having a surface to support a polishing pad, a carrier head to hold a substrate against a polishing surface of the polishing pad, a pad conditioner including a conductive body to be pressed against the polishing surface, an in-situ polishing pad thickness monitoring system including a sensor disposed in the platen to generate a magnetic field that passes through the polishing pad, and a controller configured to receive a signal from the monitoring system and generate a measure of polishing pad thickness based on a portion of the signal corresponding to a time that the sensor is below the conductive body of the pad conditioner.

Implementations may include one or more of the following features.

The conductive body may be a conductive sheet and the monitoring system may be an eddy current monitoring system in which the magnetic field generates an eddy current in the conductive sheet. The conductive body may include an aperture and the monitoring system may be an inductive monitoring system in which the magnetic field generates a current in the conductive body that flows around the aperture.

The controller may be configured to compare the signal from the monitoring system to a threshold and use only portions of the signal that meet the threshold. The threshold may be lower than a signal strength from the sensor passing under the conductive body and higher than a signal strength from the sensor passing under the carrier head and/or substrate.

The controller may be configured to generate the measure of polishing pad thickness from a logarithmic function of signal strength. The logarithmic function may be represented as

$$L = - \frac{1}{B} ln ( \frac{S}{A} )$$

where S is the signal strength, L is the polishing pad thickness, and A and B are constants.

The sensor may include a magnetic core, a coil wound around a portion of the core, and an oscillator to drive the coil. The sensor may have a resonant frequency of less than about 300 kHz.

The in-situ polishing pad thickness monitoring system may includes a plurality of sensors disposed in the platen to generate magnetic fields that pass through the polishing pad, and the controller may be configured to receive signals from the sensors and generate a measure of polishing pad thickness based on portions of the signals corresponding to times that the sensors are below the conductive body of the pad conditioner. The plurality of sensors may be spaced at equal angular intervals around an axis of rotation of the platen. The plurality of sensors may be spaced equidistant form an axis of rotation of the platen.

The apparatus may include an in-situ substrate monitoring system to generate a signal that represents the thickness of a layer on the substrate. The in-situ substrate monitoring system may be an optical monitoring system. The in-situ polishing pad monitoring system may provide a first electromagnetic induction monitoring system, and the in-situ substrate monitoring system may provide a second electromagnetic induction monitoring system. The first and second electromagnetic induction monitoring systems may have different resonant frequencies. Sensors of the first and second electromagnetic induction monitoring systems may be are positioned in different recesses in the platen.

The controller may be configured to compare the measure of thickness of the polishing pad to a threshold and generate an alert to an operator if the measure of thickness of the polishing pad reaches a threshold. The conductive body may be part of an abrasive conditioning disk of the conditioner head. The controller may e configured to generate a measure of polishing pad thickness based on a portion of the signal obtained while the substrate is being polished.

Certain implementations can include one or more of the following advantages. The thickness of the polishing pad can be detected, and the polishing pad replaced when it nears the end of its usable life, but not unnecessarily. Thus, the life of the polishing pad can be substantially maximized while reducing the likelihood of non-uniform polishing of the substrate.

The details of one or more implementations are set forth in the accompanying drawings and the description below. Other aspects, features and advantages will be apparent from the description and drawings, and from the claims.

### BRIEF DESCRIPTION OF DRAWINGS

FIG. 1 is a schematic side view, partially cross-sectional, of a chemical mechanical polishing system that includes an eddy current monitoring system configured to detect pad layer thickness.

FIG. 2 is schematic top view of a chemical mechanical polishing system.

FIG. 3 is a schematic circuit diagram of a drive system for an electromagnetic induction monitoring system.

FIG. 4 is an illustrative graph of signal strength from a sensor over multiple rotations of the platen.

FIG. 5 is an illustrative scatter plot of signal strength values for different polishing pad thicknesses.

Like reference symbols in the various drawings indicate like elements.

### DETAILED DESCRIPTION

As noted above, the conditioning process also tends to wear away the polishing pad. The polishing pad typically has grooves to carry slurry, and as the pad is worn away, these grooves become shallower and polishing effectivity degrades. Consequently, after a certain number of cycles of polishing and conditioning, the polishing pad needs to be replaced. Typically this is done simply by replacing the polishing pad after a set number of substrates have been polished, e.g., after 500 substrates. Unfortunately, the rate of pad wear need not be consistent, so the polishing pad might last more or less than the set number, which can result in wasted pad life or non-uniform polishing, respectively.

By measuring the polishing pad thickness in-situ, i.e., while the pad is on the platen, the pad can be replaced only when it reaches a threshold thickness. This can substantially maximized the pad lifetime while avoiding the risk of non-uniform polishing of the substrate.

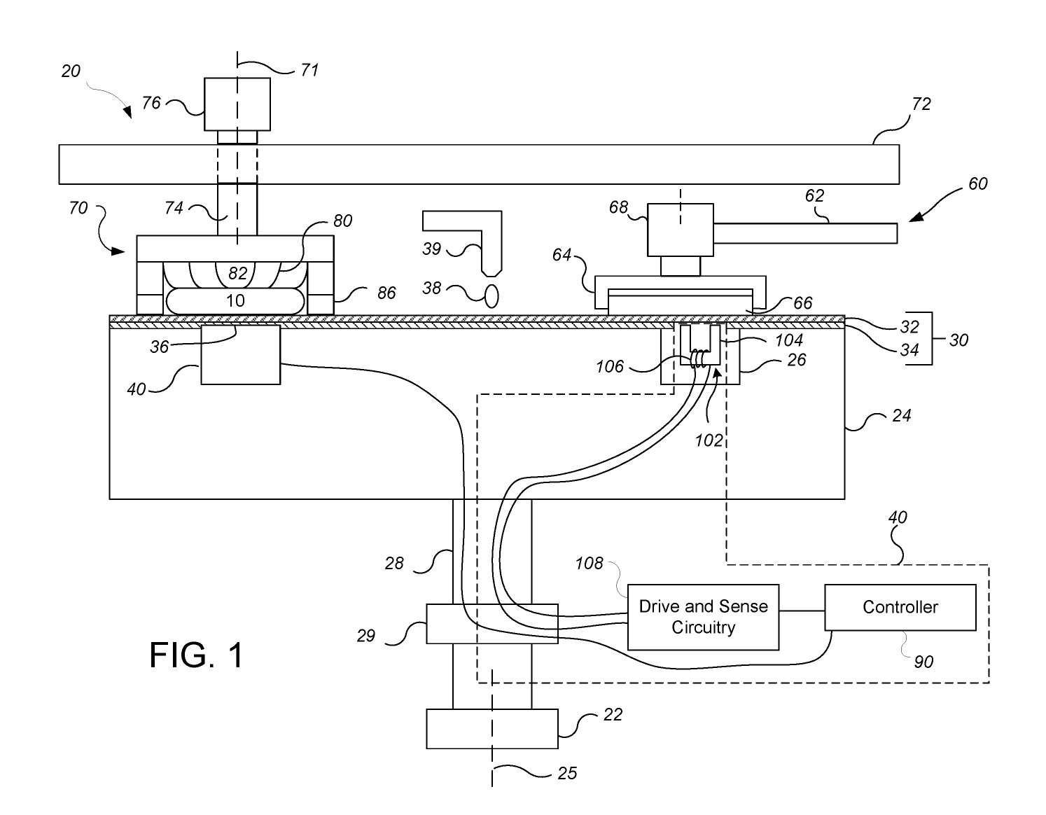

FIG. 1 illustrates an example of a polishing system 20 of a chemical mechanical polishing apparatus. The polishing system 20 includes a rotatable disk-shaped platen 24 on which a polishing pad 30 is situated. The platen 24 is operable to rotate about an axis 25. For example, a motor 22 can turn a drive shaft 28 to rotate the platen 24. The polishing pad 30 can be a two-layer polishing pad with an outer layer 34 and a softer backing layer 32.

The polishing system 20 can include a supply port or a combined supply-rinse arm 39 to dispense a polishing liquid 38, such as slurry, onto the polishing pad 30.

The polishing system 20 can also include a polishing pad conditioner 60 to abrade the polishing pad 30 to maintain the polishing pad 30 in a consistent abrasive state. The polishing pad conditioner 60 includes a base, an arm 62 that can sweep laterally over the polishing pad 30, and a conditioner head 64 connected to the base by the arm 64. The conditioner head 64 brings an abrasive surface, e.g., a lower surface of a disk 66 held by the conditioner head 64, into contact with the polishing pad 30 to condition it. The abrasive surface can be rotatable, and the pressure of the abrasive surface against the polishing pad can be controllable.

In some implementations, the arm 62 is pivotally attached to the base and sweeps back and forth to move the conditioner head 64 in an oscillatory sweeping motion across polishing pad 30. The motion of the conditioner head 64 can be synchronized with the motion of carrier head 70 to prevent collision.

Vertical motion of the conditioner head 64 and control of the pressure of conditioning surface on the polishing pad 30 can be provided by a vertical actuator 68 above or in the conditioner head 64, e.g., a pressurizable chamber positioned to apply downward pressure to the conditioner head 64. Alternatively, the vertical motion and pressure control can be provided by a vertical actuator in the base that lifts the entire arm 62 and conditioner head 64, or by a pivot connection between the arm 62 and the base that permits a controllable angle of inclination of the arm 62 and thus height of the conditioner head 64 above the polishing pad 30.

The conditioning disk 66 can provide a conductive body. For example, the conditioning disk is 66 can be a conductive material, e.g., a metal such as stainless steel, tungsten, aluminum, copper or platinum, coated with abrasive particles, e.g., diamond grit.

The carrier head 70 is operable to hold a substrate 10 against the polishing pad 30. The carrier head 70 is suspended from a support structure 72, e.g., a carousel or a track, and is connected by a drive shaft 74 to a carrier head rotation motor 76 so that the carrier head can rotate about an axis 71. Optionally, the carrier head 70 can oscillate laterally, e.g., on sliders on the carousel or track 72; or by rotational oscillation of the carousel itself. In operation, the platen is rotated about its central axis 25, and the carrier head is rotated about its central axis 71 and translated laterally across the top surface of the polishing pad 30. Where there are multiple carrier heads, each carrier head 70 can have independent control of its polishing parameters, for example each carrier head can independently control the pressure applied to each respective substrate.

The carrier head 70 can include a flexible membrane 80 having a substrate mounting surface to contact the back side of the substrate 10, and a plurality of pressurizable chambers 82 to apply different pressures to different zones, e.g., different radial zones, on the substrate 10. The carrier head can also include a retaining ring 84 to hold the substrate.

In some implementations, the polishing system 20 includes an in-situ substrate monitoring system 40 that generates a signal that represents the thickness of a layer on the substrate 10 that is being polishing. For example, the in-situ substrate monitoring system 40 could be an optical monitoring system, e.g., a spectrographic monitoring system, or an eddy current monitoring system. The in-situ substrate monitoring system 40 can be coupled to a controller 90, which can detect a polishing endpoint or adjust polishing parameters to reduce polishing non-uniformity based on the measurements. At least some sensor components of the in-situ substrate monitoring system 40, e.g., the optical port for an optical monitoring system or the core for an eddy current monitoring system, can be located in a recess formed in the platen 24.

The polishing system 20 includes an in-situ polishing pad thickness monitoring system 100 that generates a signal that represents a thickness of the polishing pad. In particular, the in-situ polishing pad thickness monitoring system 100 can be an electromagnetic induction monitoring system. The electromagnetic induction monitoring system can operate either by generation of eddy-current in a conductive layer or generation of current in a conductive loop. In operation, the polishing system 20 can use the monitoring system 100 to determine whether the polishing pad needs to be replaced.

The monitoring system 100 can include a sensor 102 installed in the recess 26 in the platen. The sensor 102 can include a magnetic core 104 positioned at least partially in the recess 26, and at least one coil 106 wound around the core 104. Drive and sense circuitry 108 is electrically connected to the coil 106. The drive and sense circuitry 108 generates a signal that can be sent to a controller 90. Although illustrated as outside the platen 24, some or all of the drive and sense circuitry 48 can be installed in the platen 24. A rotary coupler 29 can be used to electrically connect components in the rotatable platen, e.g., the coil 106, to components outside the platen, e.g., the drive and sense circuitry 108.

Optionally, a recess 36 can be formed in the bottom of the polishing pad 30 overlying the recess 26. Optionally, a portion of the core 104 can project into the recess 36. Assuming that the polishing pad 30 is a two-layer pad, the recess 36 can be constructed by removing a portion of the backing layer 32, or by removing both the backing layer 32 and a portion of the polishing layer 34. Alternatively, the polishing pad can lack such a recess; in this case the core of the sensor does project above the top of the platen 24.

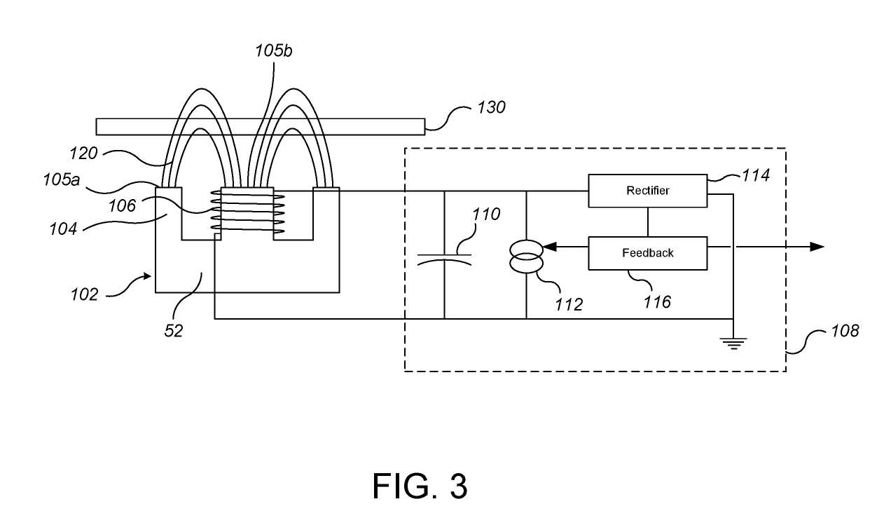

The core 104 can include two (see FIG. 1) or three (see FIG. 3) prongs 105 extending in parallel from a back portion 52. Implementations with only one prong (and no back portion) are also possible.

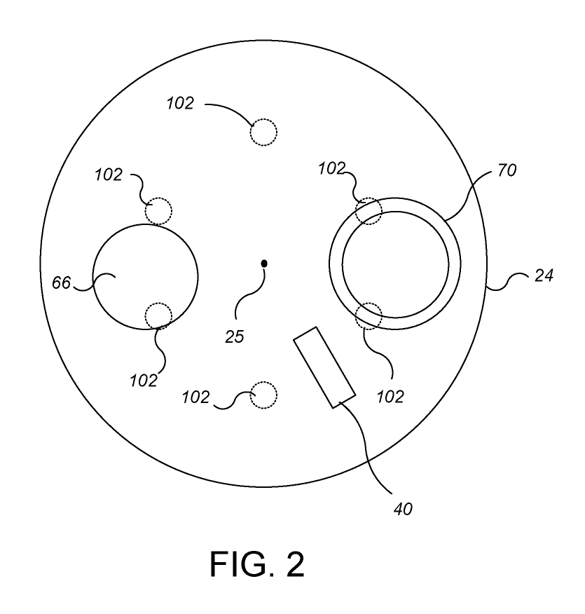

The in-situ polishing pad thickness monitoring system 100 could include just one sensor 102 (see FIG. 1). Alternatively, referring to FIG. 2, the in-situ polishing pad thickness monitoring system 100 could include a plurality of sensors 102, e.g., three, four or six sensors, installed in the platen 24. The sensors 102 can be positioned at equal angular intervals around the axis of rotation 25. The sensors 102 can be positioned equidistance from the axis of rotation 25, or the sensors 102 could be at different distances from the axis of rotation 25. Providing multiple sensors 102 can increase the rate of collection of data. The controller 90 can include a de-multiplexing function in software to select an appropriate signal (e.g., select each sensor as it travels below the conductive body), or de-multiplexing could be provided by a hardware component.

Each sensors 102 can be positioned in separate recess from the sensor for the in-situ substrate monitoring system 40. Alternatively, one sensor 102 could be positioned in the same recess as the sensor for the in-situ substrate monitoring system 40.

Referring to FIG. 3, the circuitry 108 applies an AC current to the coil 106, which generates a magnetic field 120 between two poles 105a and 105b of the core 104. In operation, a portion of the magnetic field 120 extends through the polishing pad 30. As discussed below, the magnetic field 120 will intermittently extend into a conductive body 130.

FIG. 3 illustrates an example of the drive and sense circuitry 108. The circuitry 108 includes a capacitor 110 connected in parallel with the coil 106. Together the coil 106 and the capacitor 110 can form an LC resonant tank. In operation, a current generator 112 (e.g., a current generator based on a marginal oscillator circuit) drives the system at the resonant frequency of the LC tank circuit formed by the coil 106 (with inductance L) and the capacitor 110 (with capacitance C). The configuration of coil 106, core 104 and drive and sense circuitry 108 can have a resonant frequency of about 10 kHz to 100 MHz, e.g., 10 kHz to 300 kHz.

The current generator 62 can be designed to maintain the peak to peak amplitude of the sinusoidal oscillation at a constant value. A time-dependent voltage with amplitude V₀ is rectified using a rectifier 64 and provided to a feedback circuit 106. The feedback circuit 66 determines a drive current for current generator 112 to keep the amplitude of the voltage V₀ constant. Marginal oscillator circuits and feedback circuits are further described in U.S. Pat. Nos. 4,000,458, and 7,112,960.

A conductive body 130 is placed in contact with the top surface, i.e., the polishing surface, of the polishing pad 130. Thus, the conductive body 130 is located on the far side of the polishing pad 130 from the sensor 102. In some implementations, the conductive body is the conditioner disk 66 (see FIG. 1). In some implementations the conductive body 130 can have one or more apertures therethrough, e.g., the body can be a loop. In some implementations the conductive body is a solid sheet without apertures. Either of these can be part of the conditioner disk 66.

As the platen 24 rotates, the sensor 102 sweeps below the conductive body 130. By sampling the signal from the circuitry 108 at a particular frequency, the circuitry 108 generates measurements at a plurality of locations across the conductive body 130, e.g., across the conditioner disk 66. For each sweep, measurements at one or more of the locations can be selected or combined.

When the magnetic field 120 reaches the conductive body 130, the magnetic field 120 can pass through and generate a current (e.g., if the body 130 is a loop), and/or the magnetic field create an eddy-current (e.g., if the body 130 is a sheet). This creates an effective impedance, thus increasing the drive current required for the current generator 102 to keep the amplitude of the voltage V0 constant.

The magnitude of the effective impedance depends on the distance between the sensor 102 and the conductive body 130, e.g., the conditioning disk 66. This distance depends on the thickness of the polishing pad 30. Thus, the drive current generated by the current generator 112 provides a measurement of the thickness of the polishing pad 30.

Other configurations are possible for the drive and sense circuitry 108. For example, separate drive and sense coils could be wound around the core, the drive coil could be driven at a constant frequency, and the amplitude or phase (relative to the driving oscillator) of the current from the sense coil could be used for a signal that provides a measurement of the thickness of the polishing pad 30.

A controller 90, e.g., a general purpose programmable digital computer, receives the signal from the in-situ polishing pad thickness monitoring system 100, and can be configured to generate a measure of thickness of the polishing pad 30 from the signal. As noted above, due to the conditioning process, the thickness of the polishing pad changes over time, e.g., over the course of polishing tens or hundreds of substrates. Thus, over multiple substrates, the selected or combined measurements from the in-situ polishing pad thickness monitoring system 100 provide a time-varying sequence of values indicative of the change of thickness of the polishing pad 30.

When the measure of thickness of the polishing pad 30 meets a threshold, the controller 90 can generate an alert to the operator of the polishing system 20 that the polishing pad 30 needs to be replaced. Alternatively or in addition, the measure of thickness of the polishing pad can be fed to the in-situ substrate monitoring system 40, e.g., be used by the in-situ substrate monitoring system 40 to adjust the signal from the substrate 10.

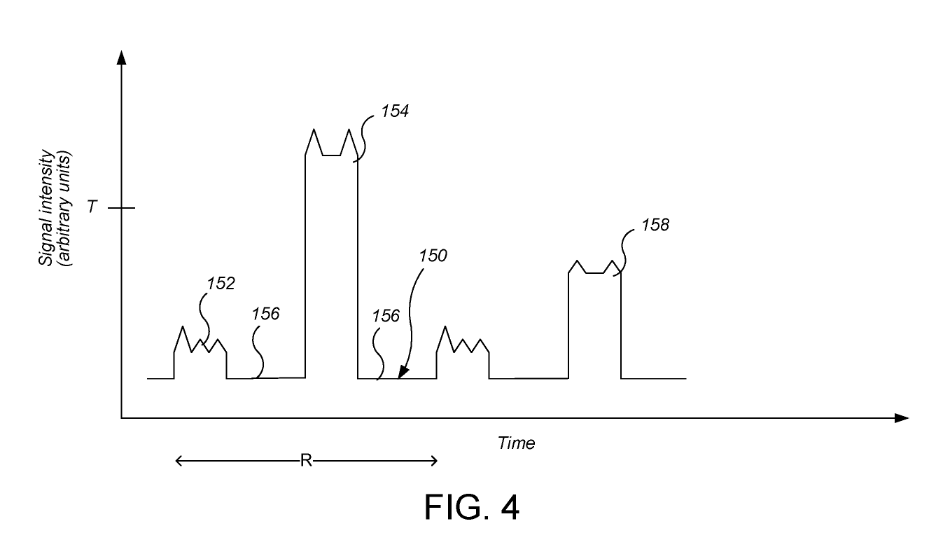

Since the sensor 102 rotates with the platen 24, the sensor 102 can generate data even when it is not below the conductive body 130. FIG. 4 illustrates a “raw” signal 150 from the sensor 102 over the course of two revolutions of the platen 24. A single revolution of the platen is indicated by the time period R.

The sensor 102 can be configured such that the closer the conductive body 130 (and thus the thinner the polishing pad 30), the stronger the signal strength. As shown in FIG. 4, initially the sensor 102 might be beneath the carrier head 70 and substrate 10. Since the metal layer on the substrate is thin, it creates only a weak signal, indicated by region 152. In contrast, when the sensor 102 is beneath the conductive body 130, the sensor 102 generates a strong signal, indicated by region 154. Between those times, the sensor 102 generates an even lower signal, indicated by regions 156.

Several techniques can be used to filter out the portion of the signal from the sensor 102 that do not correspond to the conductive body 130. The polishing system 20 can include a position sensor to sense when the sensor 102 is underneath the conductive body 120. For example, an optical interrupter can be mounted at a fixed location, and a flag can be attached to the periphery of the platen 24. The point of attachment and length of the flag is selected so that it signal that the sensor 102 is sweeping underneath the substrate conductive body 130. As another example, the polishing system 20 can include an encoder to determine the angular position of the platen 24, and use this information to determine when the sensor 102 is sweeping beneath the conductive body 130. In either case, the controller 90 can the exclude portions of the signal from periods where the sensor 102 is not below the conductive body 130.

Alternatively or in addition, the controller can simply compare the signal 150 to a threshold T (see FIG. 4) and exclude portions of the signal that do not meet the threshold T, e.g., are below the threshold T.

Due to sweep of the conditioner head 64 across the polishing pad 30, the sensor 102 may not pass cleanly below a center of the conductive body 130. For example, the sensor 102 might only pass across along an edge of the conductive body. In this case, since less conductive material is present, the signal strength will be lower, e.g., as shown by region 158 of the signal 150, and not a reliable indicator of the thickness of the polishing pad 30. An advantage of excluding portions of the signal that do not meet the threshold T is that the controller 90 an also exclude these unreliable measurements caused by the sensor 102 passing across along an edge of the conductive body 130.

In some implementations, for each sweep, the portion of the signal 150 that is not excluded can be averaged to generate an average signal strength for the sweep.

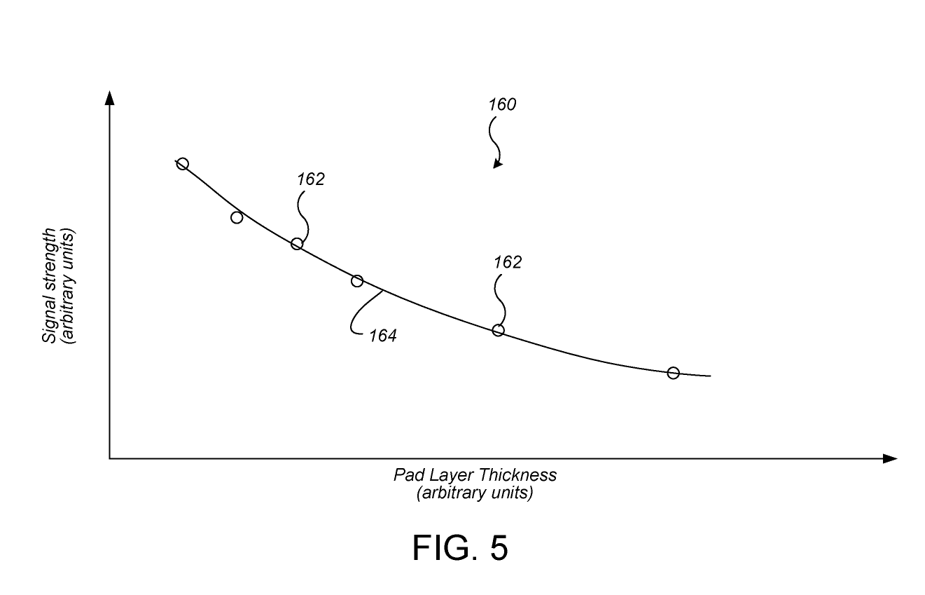

The signal strength from the sensor 102 need not be linearly related to the thickness of the polishing layer. In fact, the signal strength should be an exponential function of the thickness of the polishing layer. To establish a relationship of the signal strength to the polishing pad thickness, polishing pads of known thickness (e.g., as measured by a profilometer or the like) can be placed on the platen and the signal strength measured. FIG. 5 illustrates a scatter plot 160 of the measurements 162 of signal strength for various polishing pads of known thickness.

An exponential function 164 of thickness can then be fit to the data. For example, the function can be in the form

S=Ae^{-BL}

where S is the signal strength, L is the polishing pad thickness, and A and B are constants that are adjusted to fit the function to the data.

For the polishing pad that are later used for polishing, the controller 90 can use this function to calculate the polishing pad thickness from the signal strength. More particularly, the controller can configured to generate the measure of polishing pad thickness from an equivalent logarithmic function of signal strength, e.g., as follows

$$L = - \frac{1}{B} ln ( \frac{S}{A} )$$

However, other functions could be used, e.g., a second order or higher polynomial function, or a polyline.

Where the polishing system 20 includes an in-situ substrate monitoring system 40, the in-situ polishing pad monitoring system 100 can be a first electromagnetic induction monitoring system, e.g., a first eddy current monitoring system, and the substrate monitoring system 40 can be a second electromagnetic induction monitoring system, e.g., a second eddy current monitoring system. However, the first and second electromagnetic induction monitoring systems would be constructed with different resonant frequencies due to the different elements that are being monitored.

Although the description above has focused on using the conditioning disk as the conductive body for the in-situ polishing pad monitoring system, the conductive body could be provided by another conductive structure, e.g., a conductive disk for the dedicated use by the in-situ polishing pad monitoring system. In this case, the dedicated conductive disk need not sweep laterally across the polishing pad, and need not have an abrasive lower surface.

The in-situ polishing pad thickness monitoring system can be used in a variety of polishing systems. Either the polishing pad, or the carrier head, or both can move to provide relative motion between the polishing surface and the substrate. The polishing pad can be a circular (or some other shape) pad secured to the platen, a tape extending between supply and take-up rollers, or a continuous belt. The polishing pad can be affixed on a platen, incrementally advanced over a platen between polishing operations, or driven continuously over the platen during polishing. The pad can be secured to the platen during polishing, or there can be a fluid bearing between the platen and polishing pad during polishing. The polishing pad can be a standard (e.g., polyurethane with or without fillers) rough pad, a soft pad, or a fixed-abrasive pad.

In addition, although the foregoing description focuses on monitoring during polishing, the measurements of the polishing pad could be obtained before or after a substrate is being polished, e.g., while a substrate is being transferred to the polishing system.

Embodiments of the invention and all of the functional operations described in this specification can be implemented in digital electronic circuitry, or in computer software, firmware, or hardware, including the structural means disclosed in this specification and structural equivalents thereof, or in combinations of them. Embodiments of the invention can be implemented as one or more computer program products, i.e., one or more computer programs tangibly embodied in an information carrier, e.g., in a non-transitory machine-readable storage medium or in a propagated signal, for execution by, or to control the operation of, data processing apparatus, e.g., a programmable processor, a computer, or multiple processors or computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

A number of embodiments of the invention have been described. Nevertheless, it will be understood that various modifications may be made without departing from the spirit and scope of the invention. Accordingly, other embodiments are within the scope of the following claims.

What is claimed is:

1. An apparatus for chemical mechanical polishing, comprising:
a platen having a surface to support a polishing pad;
a carrier head to hold a substrate against a polishing surface of the polishing pad;
a pad conditioner including a conductive body to be pressed against the polishing surface;
an in-situ polishing pad thickness monitoring system including a sensor disposed in the platen to generate a magnetic field that passes through the polishing pad; and
a controller configured to receive a signal from the monitoring system and generate a measure of polishing pad thickness based on a portion of the signal corresponding to a time that the sensor is below the conductive body of the pad conditioner.

2. The apparatus of claim 1, wherein the conductive body comprises a conductive sheet and the monitoring system comprises an eddy current monitoring system in which the magnetic field generates an eddy current in the conductive sheet.

3. The apparatus of claim 1, wherein the conductive body includes an aperture and the monitoring system comprises an inductive monitoring system in which the magnetic field generates a current in the conductive body that flows around the aperture.

4. The apparatus of claim 1, wherein the controller is configured to compare the signal from the monitoring system to a threshold and use only portions of the signal that meet the threshold.

5. The apparatus of claim 4, wherein the threshold is lower than a signal strength from the sensor passing under the conductive body and higher than a signal strength from the sensor passing under the carrier head and/or substrate.

6. The apparatus of claim 1, wherein the controller is configured to generate the measure of polishing pad thickness from a logarithmic function of signal strength.

7. The apparatus of claim 6, wherein the logarithmic function comprises
$$L = - \frac{1}{B} ln ( \frac{S}{A} )$$
where S is the signal strength, L is the polishing pad thickness, and A and B are constants.

8. The apparatus of claim 1, wherein the sensor comprises a magnetic core, a coil wound around a portion of the core, and an oscillator to drive the coil.

9. The apparatus of claim 8, wherein the sensor has a resonant frequency of less than about 300 kHz.

10. The apparatus of claim 1, wherein the in-situ polishing pad thickness monitoring system includes a plurality of sensors disposed in the platen to generate magnetic fields that pass through the polishing pad, and the controller is configured to receive signals from the sensors and generate a measure of polishing pad thickness based on portions of the signals corresponding to times that the sensors are below the conductive body of the pad conditioner.

11. The apparatus of claim 10, wherein the plurality of sensors are spaced at equal angular intervals around an axis of rotation of the platen.

12. The apparatus of claim 10, wherein the plurality of sensors are spaced equidistant form an axis of rotation of the platen.

13. The apparatus of claim 1, comprising in-situ substrate monitoring system to generate a signal that represents the thickness of a layer on the substrate.

14. The apparatus of claim 13, wherein the in-situ substrate monitoring system comprises an optical monitoring system.

15. The apparatus of claim 13, wherein the in-situ polishing pad monitoring system comprises a first electromagnetic induction monitoring system, and the in-situ substrate monitoring system comprises a second electromagnetic induction monitoring system.

16. The apparatus of claim 15, wherein the first and second electromagnetic induction monitoring systems have different resonant frequencies.

17. The apparatus of claim 15, wherein sensors of the first and second electromagnetic induction monitoring systems are positioned in different recesses in the platen.

18. The apparatus of claim 1, wherein the controller is configured to compare the measure of thickness of the polishing pad to a threshold and generate an alert to an operator if the measure of thickness of the polishing pad reaches a threshold.

19. The apparatus of claim 1, wherein the pad conditioner comprises a conditioner head and wherein the conductive body comprises an abrasive conditioning disk of the conditioner head.

20. The apparatus of claim 1, wherein the controller is configured to generate a measure of polishing pad thickness based on a portion of the signal obtained while the substrate is being polished.
